(19) United States
(12) Patent Application Publication
(10) Pub. No.: US 2025/0024093 A1
(43) Pub. Date: Jan. 16, 2025

(54) METHOD FOR VIDEO COMMUNICATION AND ELECTRONIC DEVICE

(71) Applicant: BEIJING DAJIA INTERNET INFORMATION TECHNOLOGY CO., LTD., Beijing (CN)

(72) Inventor: Lixin WANG, Beijing (CN)

(21) Appl. No.: 18/435,150

(22) Filed: Feb. 7, 2024

(30) Foreign Application Priority Data
Jul. 12, 2023 (CN) 202310851557.5

(51) Int. Cl. H04N 21/431; G06F 3/0488

(52) U.S. Cl. CPC H04N 21/4312; G06F 3/0488

(57) ABSTRACT

Provided is a method for video communication. The method includes: displaying a video communication page, the video communication page displaying a special effect control; in response to a touch operation based on the special effect control, displaying a special effect panel on the video communication page and loading locally stored special effect data into a memory; wherein the special effect panel displays a special effect identifier, and the special effect data is configured to generate, in the case that the special effect identifier is triggered, special effect display information to be displayed on the video communication page.

This application is based on and claims priority to Chinese Patent Application No. 202310851557.5, filed on Jul. 12, 2023, the disclosure of which is herein incorporated by reference in its entirety.

### TECHNICAL FIELD

The present disclosure relates to the field of computer technologies, and in particular, relates to a method for video communication and an electronic device.

### BACKGROUND

In the process of video communication, a special effect can be used to enhance the interest of the video communication, and the display of the special effect depends on special effect data.

### SUMMARY

The present disclosure provides a method for video communication and an electronic device. The technical solutions of the present disclosure are as follows.

According to a first aspect of embodiments of the present disclosure, a method for video communication is provided, which is performed in an electronic device. The method includes:
displaying a video communication page, the video communication page displaying a special effect control; and
in response to a touch operation based on the special effect control, displaying a special effect panel on the video communication page and loading locally stored special effect data into a memory, wherein the locally stored special effect data is data stored in external storage which is different from the memory;
wherein the special effect panel displays a special effect identifier, and the special effect data is used to generate, in a case that the special effect identifier is triggered, special effect display information to be displayed on the video communication page.

According to a second aspect of embodiments of the present disclosure, an electronic device for video communication is provided. The electronic device includes: a processor; and a memory configured to store instructions executable by the processor, wherein the processor, when loading and executing the instructions, is caused to perform:
displaying a video communication page, the video communication page displaying a special effect control; and
in response to a touch operation based on the special effect control, displaying a special effect panel on the video communication page and loading locally stored special effect data into a memory, wherein the locally stored special effect data is data stored in external storage which is different from the memory;
wherein the special effect panel displays a special effect identifier, and the special effect data is used to generate, in a case that the special effect identifier is triggered, special effect display information to be displayed on the video communication page.

According to a third aspect of embodiments of the present disclosure, a non-transitory computer-readable storage medium is provided, the computer-readable storage medium stores instructions executable by a processor of an electronic device. The instructions, when loaded and executed by the processor of the electronic device, cause the electronic device to perform:
displaying a video communication page, the video communication page displaying a special effect control; and
in response to a touch operation based on the special effect control, displaying a special effect panel on the video communication page and loading locally stored special effect data into a memory, wherein the locally stored special effect data is data stored in external storage which is different from the memory;
wherein the special effect panel displays a special effect identifier, and the special effect data is used to generate, in a case that the special effect identifier is triggered, special effect display information to be displayed on the video communication page.

### BRIEF DESCRIPTION OF THE DRAWINGS

FIG. 1 is a schematic diagram of an implementation environment according to some embodiments of the present disclosure.

FIG. 2 is a flowchart of a method for video communication according to some embodiments of the present disclosure.

FIG. 3 is a schematic diagram of a video communication page according to some embodiments of the present disclosure.

FIG. 4 is a schematic diagram of another video communication page according to some embodiments of the present disclosure.

FIG. 5 is a schematic diagram of another video communication page illustrating a special effect panel according to some embodiments of the present disclosure.

FIG. 6 is a flowchart of a method for video communication based on special effect display information according to some embodiments of the present disclosure.

FIG. 7 is a schematic diagram of video communication pages illustrating the display of a star special effect according to some embodiments of the present disclosure.

FIG. 8 is a schematic diagram of video communication pages illustrating the display of a hairstyle special effect according to some embodiments of the present disclosure.

FIG. 9 is a flowchart of a method for displaying a portrait special effect according to some embodiments of the present disclosure.

FIG. 10 is a schematic diagram of video communication pages illustrating the display of a portrait special effect according to some embodiments of the present disclosure.

FIG. 11 is a schematic diagram of video communication pages illustrating the display of a plurality of special effect mode labels in a special effect panel according to some embodiments of the present disclosure.

FIG. 12 is a schematic diagram of video communication pages illustrating the switching and displaying of special effect identifiers according to some embodiments of the present disclosure.

FIG. 13 is a flowchart of the loading of special effect data under a video communication scenario according to some embodiments of the present disclosure.

FIG. 14 is a block diagram of an apparatus for video communication according to some embodiments of the present disclosure.

FIG. 15 is a schematic structural diagram of an electronic device for video communication according to some embodiments of the present disclosure.

### DETAILED DESCRIPTION

A special effect can be used in the video communication, and the display of the special effect depends on special effect data. In the related art, the special effect data is generally preloaded at the time of the instant messaging application being started, and then in the case that video communication is performed based on the instant messaging application, special effect display is performed on a video communication page directly based on the preloaded special effect data. However, by preloading the special effect data at the time of starting the instant messaging application, in one aspect, the time consumption for starting the instant messaging application is increased; and in another aspect, in the case that the instant messaging application is started without video communication, the preloaded resources is wasted.

In the present disclosure, the locally stored special effect data is loaded into the memory at the time of the special effect panel being displayed by touching on the terminal. It should be noted that the locally stored special effect data is stored in a component in the terminal which is different from the memory. In some embodiments, the special effect data is stored in external storage of the local terminal, wherein the external storage includes a hard disk. Because the special effect panel is displayed by a user's operation such as touching the screen of the terminal, special effects are more likely used by the user. Therefore, the timing of preloading the special effect data is determined at the time when the touch operation is performed based on the special effect control, such that the display of the special effect panel and the preloading of the special effect data are synchronous, which facilitates the subsequent use of special effects in the video communication process and avoids the waste of preloaded resources caused by preloading special effect data at the time when the current application is started but video communication is not performed later or special effects are not used in the video communication process. In addition, it reduces the time consumption for starting the application because the special effect data is not preloaded at the time of the application being started. In some embodiments, on the premise of avoiding the waste of preloaded resources and reducing the time consumption for starting the application, special effects can be rapidly displayed in the video communication process, the interest on the video communication is enhanced, and the interactivity between users is enhanced.

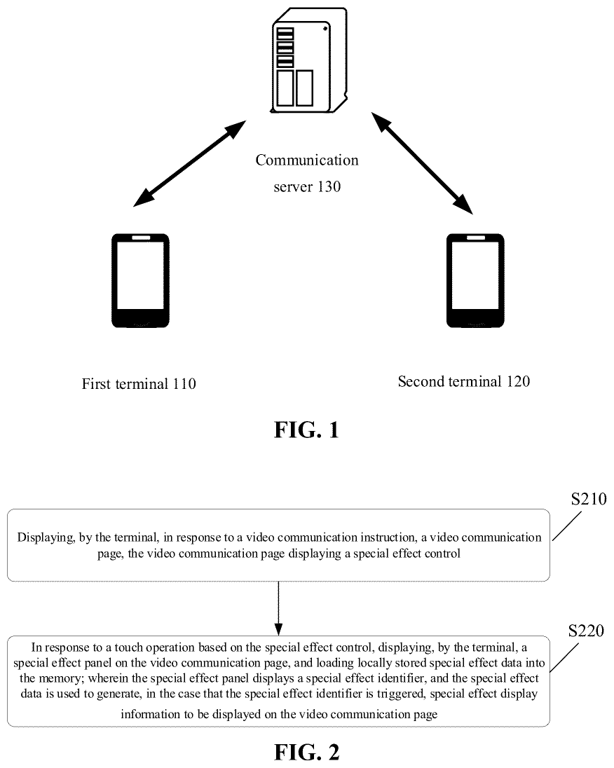

Referring to FIG. 1, which is a schematic diagram of an implementation environment according to some embodiments of the present disclosure, the implementation environment includes a first terminal 110, a second terminal 120, and a communication server 130, and both the first terminal 110 and the second terminal 120 are in data communication with the communication server 130 via a network.

The first terminal 110 initiates a video communication request aiming for the second terminal 120, and sends the video communication request to the communication server 130; the communication server 130 forwards the received video communication request to the second terminal 120; and the second terminal 120 responds, upon receiving the video communication request, to the video communication request, e.g., agrees with the video communication request, and the communication server 130 establishes, upon receiving the agreement response from the second terminal 120, a communication link between the first terminal 110 and the second terminal 120. In the present disclosure, the terminal currently executing the method for video communication is the first terminal 110 or the second terminal 120, the terminal currently executing the method for video communication is also referred to as a local terminal, and the terminal which is in video communication with the local terminal is also referred to as a opposite terminal. In some instances, the first terminal 110 is the local terminal and the second terminal 120 is the opposite terminal, or the second terminal 120 is the local terminal and the first terminal 110 is the opposite terminal.

Both the first terminal 110 and the second terminal 120 are in communication with the communication server 130 based on a browser/server (B/S) mode or a client/server (C/S) mode. The first terminal 110 may be an electronic device, such as a smart phone, a tablet computer, a laptop, a digital assistant, a smart wearable device, and a vehicle terminal, and further includes software running in the electronic device, such as application programs; and the second terminal 120 may include an electronic device, such as a smart phone, a tablet computer, a laptop, a digital assistant, a smart wearable device, and a vehicle terminal, and further includes software running in the electronic device, such as application programs. In one example, the application program running in the first terminal 110 and the second terminal 120 are an instant messaging application. The operating systems running on the first terminal 110 and the second terminal 120 in some embodiments of the present disclosure include, but are not limited to, an Android system, an iOS system, Linux, windows, and the like.

The communication server 130 establishes a communication connection with the first terminal 110 in a wired or wireless manner, the communication server 130 establishes a communication connection with the second terminal 120 in a wired or wireless manner, and the communication server 130 includes an independently operating server, or distributed servers, or a server cluster composed of a plurality of servers, wherein the server, in some embodiments, is a cloud server. In some embodiments, the communication server 130 includes a database storing special effect data. In some embodiments, the communication server 130 is configured to provide video communication services for the instant messaging applications running on the first terminal 110 and the second terminal 120. The first terminal 110 and the second terminal 120 can log on the communication server 130 through the instant messaging applications. The communication server 130 establishes a communication link between the first terminal 110 and the second terminal 120, and then sends the video data from the instant messaging application running on the first terminal 110 to the instant messaging application running on the second terminal 120, or sends the video data from the instant messaging application running on the second terminal 120 to the instant messaging application running on the first terminal 110. Based on the above, video communication is achieved.

The embodiments of the present disclosure provide a method for video communication, where an execution subject thereof is a terminal which is also referred to as a local terminal, and the terminal is the first terminal or the second terminal described above. Referring to FIG. 2, the method includes the following processes.

In S210, the terminal displays, in response to a video communication instruction, a video communication page, the video communication page displaying a special effect control.

In the embodiments of the present disclosure, the special effect control is a control capable of displaying special effect display information on the video communication page. In some embodiments, the special effect control includes a beauty special effect, a makeup special effect, a body shaping special effect, a filter special effect, and the like, and the special effect control is configured to display the beauty special effect on the video communication page, the makeup special effect on the video communication page, the body shaping special effect on the video communication page, the filter special effect on the video communication page, and the like.

The special effect control may be displayed at any position of the video communication page. In some embodiments, the special effect control is displayed on a side edge of the video communication page, and the special effect control may be identified by text, images or characters.

In the embodiments of the present disclosure, in the case that an instant messaging application is started and a local-terminal user needs to initiate a video communication request aiming for an opposite-terminal user, a video communication instruction is triggered based on the instant messaging application, and the video communication instruction can instruct the opposite-terminal user that is to be in video communication with the local-terminal user. The opposite terminal is a terminal in video communication with the local terminal, and the opposite-terminal user is a user in video communication with the user of the local terminal. In some embodiments, the video communication instruction is triggered based on an interaction page with an opposite-terminal user identifier, e.g., based on a video communication control in the interaction page. In other embodiments, the video communication instruction is triggered based on a friend list of a local-terminal user identifier. In some embodiments, an opposite-terminal user identifier that is to be in video communication is determined in the friend list, and the video communication instruction is triggered based on the opposite-terminal user identifier. In some embodiments, a function menu is displayed by pressing the opposite-terminal user identifier for a long time (i.e., a long press operation), and a video communication instruction is generated through a touch operation performed on the video communication control in the function menu. The touch operation includes a touch on a touch screen or a click on the screen.

It should be appreciated that the current application as an instant messaging application is taken as an example. In some embodiments, the current application is another type of application with a video communication function, such as a video sharing application, a live streaming application, and an online shopping application.

In addition, the embodiments of the present disclosure take the case that the terminal displays, in response to the video communication instruction, the video communication page as an example, and in some other embodiments, the terminal displays, in response to other instructions or operations, the video communication page. The way of displaying the video communication page is not limited in the present disclosure. For example, in the case that other users in a group are in video communication, a video communication entry is displayed on an interaction page of the group, the local-terminal user triggers the video communication entry, and the terminal displays, in response to the operation of triggering the video communication entry, the video communication page.

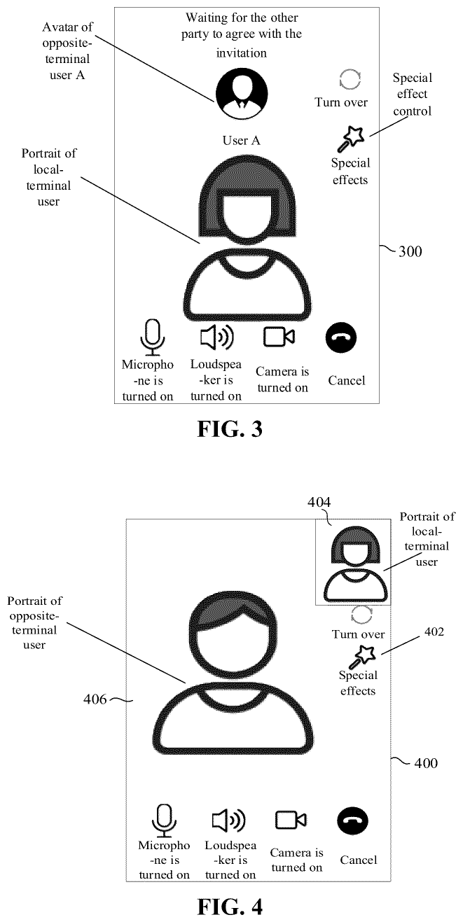

Under different communication states, the contents displayed on the video communication page are different. Referring to FIG. 3, FIG. 3 is a schematic diagram of a video communication communication between two users is not started. In the case of waiting for the response of the opposite-terminal user and a camera control being in an open state, the video communication page 300 displays environmental information around the local terminal and a video communication function control. The environmental information around the local terminal includes environmental image information acquired by capturing the environment around the local terminal through an image acquisition apparatus of the local terminal, which may include portrait information of the local-terminal user, and the video communication function control includes a special effect control, a microphone control, a loudspeaker control, a camera control, a video cancellation control, and the like. In the illustrated embodiment, a portrait of the local-terminal user is displayed in a center of the page before the communication between the two users, and a special effect control is displayed at a side edge of the video communication page 300. In FIG. 3, the special effect control, the microphone control, the loudspeaker control, and the camera control, and the video cancellation control are shown as corresponding icons. A cancel control “Cancel” is displayed under the phone icon. Further, the status of the microphone, the loudspeaker, and the camera are indicated to be turned on (i.e., an “on” state) by a text, respectively. The video communication page 300 also displays an avatar of the opposite-terminal user A, and status of invitation “Waiting for the other party to agree with the invitation.”

Referring to FIG. 4, FIG. 4 is a schematic diagram of a video communication page 400 of a local terminal according to one embodiment of the present disclosure, in which two users are in communication. In the case that the opposite-terminal user has successfully made a response and both the camera controls of the opposite terminal and the local terminal are in an “on” state, the video communication page 400 displays environmental information around the local terminal, environmental information around the opposite terminal, and the video communication function control. The environmental information around the local terminal includes environmental image information acquired by capturing the environment around the local terminal through the image acquisition apparatus of the local terminal, which may include portrait information of the local-terminal user. The environmental information around the opposite terminal includes environmental image information acquired by capturing the environment around the opposite terminal through an image acquisition apparatus of the opposite terminal, which may include portrait information of the opposite-terminal user. The video communication function control includes a special effect control 402, a microphone control, a loudspeaker control, a camera control, a video cancellation control, and the like. In FIG. 4, the special effect control 402, the microphone control, the loudspeaker control, and the camera control, and the video cancellation control are shown as corresponding icons. A cancel control “Cancel” is displayed under the phone icon. Further, the statuses of the microphone, the loudspeaker, and the camera are indicated to be turned on (i.e., an “on” state) by a text, respectively. In some embodiments, in the case that the local-terminal user lightly touches the video communication page, the special effect control, the microphone control, the loudspeaker control, the camera control, the video cancellation control and the like are hidden.

In some embodiments, the environmental information around the local terminal and the environmental information around the opposite terminal are respectively displayed through different display windows on the video communication page. In some embodiments, the environmental information around the local terminal is displayed on a local-terminal display window 404, and the environmental information around the opposite terminal is displayed on an opposite-terminal display window 406. In the embodiment illustrated in FIG. 4, the environmental information around the local terminal is displayed on a local-terminal display window 404. The local-terminal display window 404 shows a portrait of the local-terminal user and is displayed at a corner of the video communication page 400. The environmental information around the opposite terminal is displayed in a center portion of the video communication page. The portion displaying the environmental information around the opposite terminal is an opposite-terminal display window 406. A portrait of the opposite-terminal user is displayed in the opposite-terminal display window 406. In the illustrated embodiment, the opposite-terminal display window 406 is at the center of the video communication page 400. The local-terminal display window and the opposite-terminal display window are displayed in an overlapping manner or an independent manner.

In some embodiments, the display size of the local-terminal display window and the display size of the opposite-terminal display window are identical or different; and both the local-terminal user and the opposite-terminal user can adjust the display size of the local-terminal display window and the display size of the opposite-terminal display window in the video communication page displayed by the used terminals to meet the use requirements of the users and improve the user experience.

In some embodiments, in order to facilitate the local-terminal user to clearly understand the environmental information around the opposite terminal and the opposite-terminal user, the size of the local-terminal display window is set to be smaller than the size of the opposite-terminal display window.

In S220, in response to a touch operation based on the special effect control, the terminal displays a special effect panel on the video communication page and loads locally stored special effect data into the memory, wherein the locally stored special effect data is data stored in external storage which is different from the memory; wherein the special effect panel displays a special effect identifier, and the special effect data is used to generate, in the case that the special effect identifier is triggered, special effect display information to be displayed on the video communication page. In some embodiments, the local terminal includes a central processing unit (CPU), a memory, and external storage, wherein the external storage is configured to store data for a long term, the memory is configured to temporarily store the data, the memory is a bridge between the CPU and the external storage, and the data is processed by CPU only in the case that the data is loaded into the CPU from the memory upon the data being loaded into the memory from the external storage. Thus, the special effect data is stored in the external storage of the local terminal, and the local terminal can display the special effect data or trigger the special effect data only in the case that the special effect data is loaded into the memory from the external storage. The special effect display information includes special effect display on the video communication page. In some embodiments, the special effect display information may include one or more elements. In some examples, elements may be an image such as a star, a heart, a cake, or a candle. In other examples, the elements may be a sound, music, or a text. In some embodiments, the special effect display information may be processed information, and the processed information may be a portrait processed with a special effect such as a beauty effect or a markup effect.

In response to the touch operation based on the special effect control, the special effect panel is displayed on the video communication page, and locally stored special effect data is loaded into the memory, namely, the two operations of displaying the special effect panel and loading the special effect data into the memory are synchronously performed in some embodiments. The touch operation may be a touch, by a finger of a user, on the special effect control or the touch operation may be a click, via a mouse by the user, on the special effect control.

In some embodiments, the special effect panel displays a plurality of special effect identifiers, and the special effect data includes special effect data corresponding to each of the plurality of special effect identifiers, and thus in the case that any special effect identifier is triggered, special effect display information corresponding to the triggered special effect identifier is generated based on special effect data corresponding to the triggered special effect identifier. In some embodiments, different special effect identifiers correspond to different special effect display effects, the special effect data corresponding to any special effect identifier includes special effect description information, special effect application model data, and the like, and different special effect display effects need to be based on different special effect application model data, so different special effect identifiers correspond to different special effect application model data. In some embodiments, the special effects are special effects configured for the video communication page, namely, special effect display information is displayed on the whole video communication page. For example, in the case that the special effect is addition of elements, the special effect display information may be display of the elements at preset positions on the entire video communication page. In some other embodiments, the special effects are special effects configured for a local-terminal display window and/or an opposite-terminal display window in the video communication page, namely, the special effect display information is displayed on the local-terminal display window and/or the opposite-terminal display window. For example, in the case that the special effect is beauty, makeup, or body shaping, the special effect display information may be a portrait processed with the special effect of beauty, makeup, or body shaping, and the special effect display information is displayed on the local-terminal display window and/or the opposite-terminal display window. The display position of the special effect display information on the video communication page is not limited in the embodiments of the present disclosure.

The special effect data needs to be preloaded before use, namely, the special effect data is stored in the memory, and the data stored in the memory can be directly used. Therefore, the special effect data is loaded into the memory herein, which is convenient for subsequent generation of special effect display information directly based on the special effect data in the memory.

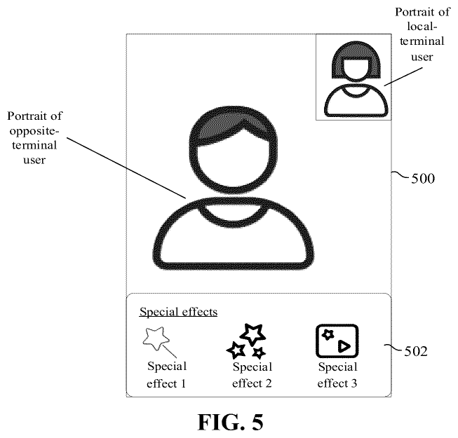

In some embodiments, the special effect identifier includes a text identifier, an image identifier, or a combined identifier of a text identifier and an image identifier; and in the case that the special effect identifier includes an image identifier, the special effect display result corresponding to the special effect identifier is reflected through the image identifier, therefore a user can conveniently select the image identifier based on the special effect display effect required to be displayed. Referring to FIG. 5, a schematic diagram of a video communication page 500 illustrating a special effect panel 502 is shown. The special effect panel 502 is displayed at the bottom of the video communication page so as to avoid affecting the display of other information on the video communication page, and the special effect panel displays a plurality of special effect identifiers. In the illustrated embodiment shown in FIG. 5, the special effect identifiers are combined identifiers of text identifiers and image identifiers, and include a special effect 1 and an image corresponding special effect display effect, a special effect 2 and an image corresponding special effect display effect, a special effect 3 and an image corresponding special effect display effect. In the illustrated embodiment, the special effect panel 502 is displayed on a half-screen page.

In some embodiments, the special effect panel displays a plurality of special effect identifiers, and the special effect data is configured to generate special effect display information to be displayed on the video communication page in the case that any special effect identifier is triggered, namely, the special effect display information in the embodiments of the present disclosure is information to be displayed on the video communication page in the video communication process.

In some embodiments, said displaying the video communication page includes:
displaying the video communication page, and in the case that the special effect data is not stored in the local terminal, acquiring the special effect data from a communication server and storing the special effect data in the local terminal. In some embodiments, the communication server is the communication server 130 shown in FIG. 3. Storing the special effect data in the local terminal means that the special effect data is downloaded from the communication server to the external storage of the local terminal and stored by the external storage.

In the above step, the two operations of displaying the video communication page and determining whether special effect data is stored in the local terminal or not are simultaneously performed, and in the case that the special effect data is not stored in the local terminal, the special effect data is acquired from the communication server via a network, and the acquired special effect data is stored in the local terminal.

Therefore, in the case of video communication being started, it is determined whether special effect data for use is locally stored or not; if not, the special effect data is acquired from the communication server and stored in the local terminal; and if yes, no operation to acquire the special effect data from the communication server is performed. By ensuring that the special effect data is stored in the local terminal in the case that the video communication is started, it is convenient to directly preload the locally stored special effect data in response to the touch operation based on the special effect control, which improves the efficiency of preloading the special effect data and further improves the display efficiency of the special effect display information.

In some embodiments, in response to the video communication instruction, the video communication page is displayed, and in the case that the special effect data is not stored in the local terminal, the special effect data is acquired and stored in the local terminal. The triggering manner of the video communication instruction is described in detail in S210, and is not repeated herein.

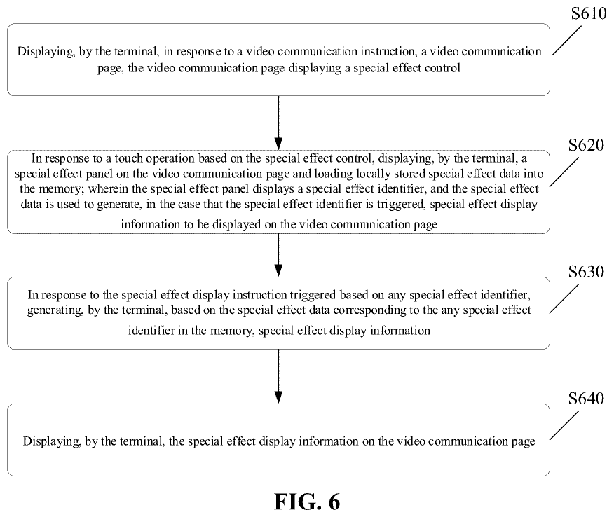

In some embodiments, referring to FIG. 6, a method for video communication based on special effect display information is shown. The method includes the following processes.

In S610, the terminal displays, in response to a video communication instruction, a video communication page, the video communication page displaying a special effect control.

In the embodiments of the present disclosure, the special effect control is a control capable of causing display of special effect display information on the video communication page. In some embodiments, the special effect control is configured as an icon which shows the special effect result. In some embodiments, the special effect control includes a beauty special effect, a makeup special effect, a body shaping special effect, a filter special effect, and the like, and then the special effect control is configured to display the beauty special effect on the video communication page, the makeup special effect on the video communication page, the body shaping special effect on the video communication page, the filter special effect on the video communication page, and the like when the special effect control is triggered.

In some embodiments, the special effect control is displayed at any position on the video communication page. In some embodiments, the special effect control is displayed on a side edge of the video communication page, and in addition, the special effect display control is identified by images or characters.

In the embodiments of the present disclosure, the terminal is a local terminal who initiates the video communication, in the case that an instant messaging application is started and a local-terminal user needs to initiate a video communication request aiming for an opposite-terminal user, a video communication instruction is triggered based on the instant messaging application, the video communication instruction indicating the opposite-terminal user that is to be in video communication. The opposite terminal is a terminal in video communication with the local terminal, and the opposite-terminal user is a user in video communication with the user of the local terminal. In some embodiments, the video communication instruction is triggered based on an interaction page with an opposite-terminal user identifier, e.g., based on a video communication control in the interaction page. In some embodiments, the video communication instruction is triggered based on a friend list of a local-terminal user identifier. In some embodiments, an opposite-terminal user identifier that is to be in video communication is determined from the friend list, and the video communication instruction is triggered based on the opposite-terminal user identifier or triggered by performing an operation on the opposite-terminal user identifier. In some embodiments, a function menu is displayed by pressing the opposite-terminal user identifier for a long time, and a video communication instruction is generated through a touch operation performed on the video communication control in the function menu.

The embodiments of the present disclosure only take the current application being an instant messaging application as an example, and in some embodiments, the current application is another type of application with a video communication function, such as a video sharing application, a live streaming application, and an online shopping application.

In addition, the embodiments of the present disclosure take the case that the terminal displays, in response to the video communication instruction, the video communication page as an example, and in some other embodiments, the terminal displays, in response to other instructions or operations, the video communication page. The way of displaying the video communication page in the present disclosure is limited. In some embodiments, in the case that other users in a group are already in video communication, a video communication entry is displayed on an interaction page of the group, the local-terminal user triggers the video communication entry, and the terminal displays, in response to the trigger operation on the video communication entry, the video communication page.

Under different communication states, the contents displayed on the video communication page are different. Referring to FIG. 3, in the case of waiting for the response from the opposite-terminal user and a camera control being in an open state, the video communication page 300 displays environmental information around the local terminal and a video communication function control. The environmental information around the local terminal includes environmental image information acquired by capturing the environment around the local terminal through an image acquisition apparatus of the local terminal, which may include portrait information of the local-terminal user, and the video communication function control includes a special effect control, a microphone control, a loudspeaker control, a camera control, a video cancellation control, and the like.

Referring to FIG. 4, in the case that the opposite-terminal user successfully makes a response and both the camera controls of the opposite terminal and the local terminal are in an open state, the video communication page 400 displays environmental information around the local terminal, environmental information around the opposite terminal, and the video communication function control. The environmental information around the local terminal includes environmental image information acquired by capturing the environment around the local terminal through an image acquisition apparatus of the local terminal, which may include portrait information of the local-terminal user; the environmental information around the opposite terminal includes environmental image information acquired by capturing the environment around the opposite terminal through an image acquisition apparatus of the opposite terminal, which may include portrait information of the opposite-terminal user; and the video communication function control includes a special effect control, a microphone control, a loudspeaker control, a camera control, a video communication cancellation control, and the like, and in the case that the local-terminal user lightly touches the video communication page, the special effect control, the microphone control, the loudspeaker control, the camera control, the video cancellation control and the like are hidden.

In some embodiments, the environmental information around the local terminal and the environmental information around the opposite terminal are respectively displayed through different display windows on the video communication page. In some embodiments, the environmental information around the local terminal is displayed on a local-terminal display window, and the environmental information around the opposite terminal is displayed on an opposite-terminal display window. The local-terminal display window and the opposite-terminal display window are displayed in an overlapping manner or in an independent manner.

In some embodiments, the display size of the local-terminal display window and the display size of the opposite-terminal display window are identical or different; and both the local-terminal user and the opposite-terminal user can adjust the display size of the local-terminal display window and the display size of the opposite-terminal display window in the video communication page displayed by the used terminals so as to meet the use requirements of the users and improve the user experience.

In some embodiments, in order to facilitate the local-terminal user to clearly understand the environmental information around the opposite terminal and the opposite-terminal user, the size of the local-terminal display window is set to be smaller than the size of the opposite-terminal display window as illustrated in the example in FIG. 4.

In S620, in response to a touch operation based on the special effect control, the terminal displays a special effect panel on the video communication page and loads locally stored special effect data into the memory, wherein the locally stored special effect data is data stored in external storage which is different from the memory; and wherein the special effect panel displays a special effect identifier, and the special effect data is used to generate, in the case that the special effect identifier is triggered, special effect display information to be displayed on the video communication page.

In response to the touch operation based on the special effect control, the special effect panel is displayed on the video communication page, and locally stored special effect data is loaded into the memory, namely, the two operations of displaying the special effect panel and loading the special effect data into the memory are synchronously performed in some embodiments.

In some embodiments, the special effect panel displays a plurality of special effect identifiers, the special effect data includes special effect data corresponding to each of the plurality of special effect identifiers, and thus in the case that any special effect identifier is triggered, special effect display information corresponding to the triggered special effect identifier is generated based on special effect data corresponding to the triggered special effect identifier. In some embodiments, different special effect identifiers correspond to different special effect display effects, the special effect data corresponding to any special effect identifier includes special effect description information, special effect application model data, and the like, and different special effect display effects are based on different special effect application model data, so different special effect identifiers correspond to different special effect application model data. In some embodiments, the special effects are special effects configured for the video communication page, namely, special effect display information is displayed on the whole page of the video communication page; and in some other embodiments, the special effects are special effects configured for a local-terminal display window and/or an opposite-terminal display window in the video communication page, namely, the special effect display information is displayed on the local-terminal display window and/or the opposite-terminal display window, which is not limited in the embodiments of the present disclosure.

The special effect data needs to be preloaded before use, namely, the special effect data is stored in the memory, and the data stored in the memory can be directly used. Therefore, the special effect data is loaded into the memory herein to facilitate the subsequent generation of special effect display information based on the special effect data in the memory.

In some embodiments, the special effect identifier includes a text identifier, an image identifier, or a combined identifier of a text identifier and an image identifier; and in the case that the special effect identifier includes an image identifier, the special effect display result corresponding to the special effect identifier is reflected through the image identifier, and thus a user can conveniently select the image identifier based on the special effect display effect required to be displayed. Referring to FIG. 5, a schematic diagram of a special effect panel 502 is shown, where the special effect panel 502 is displayed at the bottom of the video communication page 500 so as to avoid affecting the display of other information on the video communication page, and the special effect panel 502 displays a plurality of special effect identifiers. The special effect identifiers are combined identifiers of text identifiers and image identifiers, and include a special effect 1, a special effect 2, a special effect 3, and corresponding images, as shown in FIG. 5.

In S630, the terminal generates, in response to the special effect display instruction triggered based on a special effect identifier, special effect display information based on the special effect data corresponding to the special effect identifier in the memory. The special effect display information is information to be displayed on the video communication page in the video communication process.

As can be seen from S630, the terminal generates, in response to the special effect identifier being triggered, the special effect display information based on the special effect data corresponding to the special effect identifier in the memory.

In the case that the special effect panel displays a plurality of special effect identifiers, in response to any special effect identifier being triggered, special effect display information corresponding to the special effect identifier is generated directly based on special effect data preloaded into the memory and corresponding to the special effect identifier.

In S640, the terminal displays the special effect display information on the video communication page.

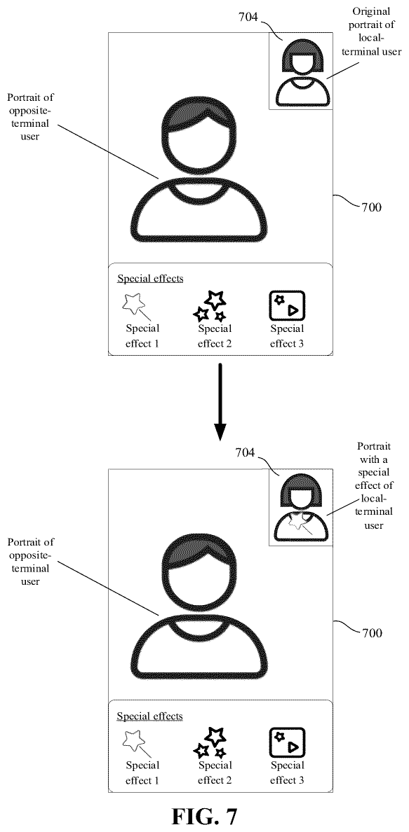

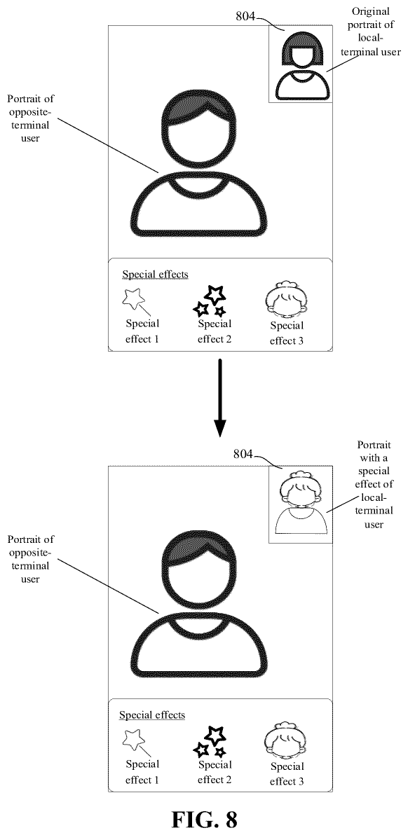

In the case that the special effect display information is generated, the special effect display information is displayed on the video communication page. That is, the special effect display information in the embodiments of the present disclosure is displayed in the video communication process, which can enhance the interest of video communication. For example, in FIG. 5, one of the special effect identifiers is one star. The terminal displays, in response the image of one star is triggered, one star at one or more preset positions or multiple positions on the video communication page. In some embodiments, referring to FIG. 7, an image of a star is displayed in the local-terminal display window 704 of the video communication page 700. In other embodiment, referring to FIG. 8, one of the special effect identifiers is a hairstyle, and in response to the image of the hairstyle being triggered, the local terminal changes the hairstyle of the local terminal user to the special effect hairstyle in the local-terminal display window 804.

In some embodiments, the video communication page displays a local-terminal display window configured to display environmental information around a local terminal; and
said displaying the special effect display information on the video communication page includes:
displaying the special effect display information on the local-terminal display window.

According to the above content of the embodiments of the present disclosure, the video communication page displays the environmental information around the local terminal and the video communication function control, wherein the environmental information around the local terminal includes environmental image information acquired by capturing the environment around the local terminal through an image acquisition apparatus of the local terminal. The local terminal displays, in response to a special effect display instruction triggered based on any special effect identifier, special effect display information on the local-terminal display window. That is, the local terminal displays the special effect display information on the local-terminal display window of the video communication page by triggering any special effect identifier, and the display information displayed in the opposite-terminal display window of the video communication page is not affected; and the opposite-terminal display window of the video communication page of the opposite terminal displays the special effect display information which is triggered to display by the local terminal.

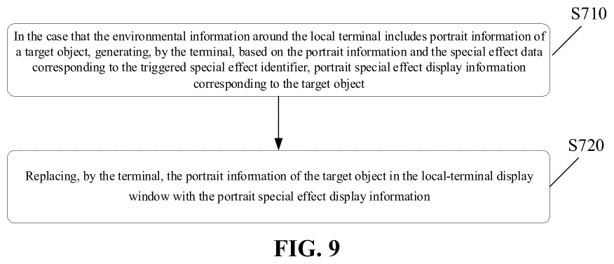

In some embodiments, the video communication page displays a local-terminal display window configured to display environmental information around the local terminal, wherein the environmental information around the local terminal includes portrait information around the local terminal and object information around the local terminal, and the portrait information includes human face information, body information, and the like; correspondingly, the special effect display information includes portrait special effect display information, wherein the portrait special effect display information is the display information acquired by adding special effects to the portrait information around the local terminal. Correspondingly, referring to FIG. 9, a portrait special effect display method is shown. The method is performed by a local terminal. The method includes the following processes.

In S710, the terminal generates, in the case that the environmental information around the local terminal includes portrait information of a target object, portrait special effect display information corresponding to the target object based on the portrait information and the special effect data corresponding to the triggered special effect identifier. The target object may be a user of the local terminal.

Different special effect identifiers correspond to different special effect templates, and different special effect templates are achieved based on different special effect application model data. The special effect template is a reusable special effect that, by applying the special effect template to a portrait, can make the portrait conform to the display effect of the special effect template. In some embodiments, the special effect template is a facial expression template, by applying the facial expression template to the portrait, the original facial expression of the portrait is replaced, and the portrait has the facial expression of the special effect template. The special effect application model data is the display data of the special effect template, i.e., the data used to determine how the special effect template is displayed. The special effect application model data defines the display style of the special effect template, such as the position, shape, and color of each special effect element in the special effect template. In this way, by processing the portrait information based on the special effect application model data, the effect of applying the special effect template on the portrait is achieved.

According to the above descriptions, the special effect data includes special effect application model data, and thus in the case that the triggered special effect identifier is determined, the portrait special effect display information corresponding to the target object is acquired by performing the corresponding special effect addition process on the portrait information based on the special effect application model data in the special effect data corresponding to the special effect identifier.

In some embodiments of the present disclosure, the special effect processing is to perform special effect addition processing on portrait information, and in the case that the portrait information of the target object is not included in the environmental information around the local terminal, prompt information is displayed on the video communication page, wherein the prompt information includes: portrait information is not detected, and special effects cannot be displayed, and the like.

In S720, the terminal replaces the portrait information of the target object in the local-terminal display window with the portrait special effect display information.

Upon the portrait information of the target object being subjected to special effect addition based on the special effect template, corresponding portrait special effect display information is acquired. Because the special effect display information needs to be displayed finally, the portrait information of the target object in the local-terminal display window is replaced with the portrait special effect display information upon adding special effect.

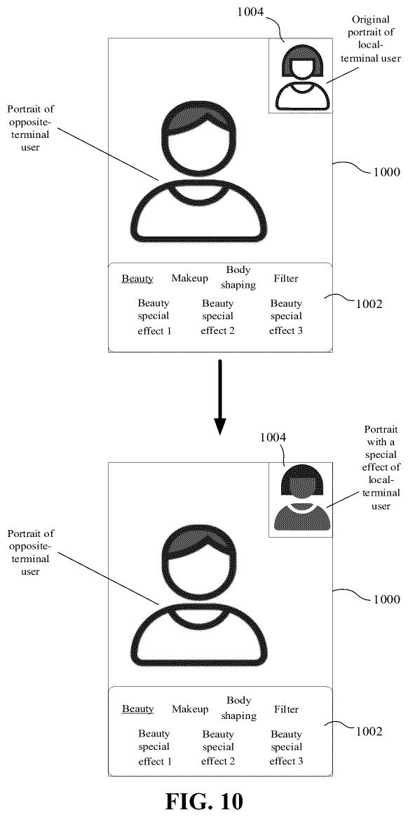

Referring to FIG. 10, a special effect addition process is illustrated. As shown in the video communication page 1000 (the top page), the original portrait information of the target object is displayed on the local-terminal display window 1004. After the special effect control is triggered, the special effect panel 1002 is displayed on the video communication page 1000, in which a plurality of special effect identifiers are displayed. Upon any special effect identifier (e.g., special effect 1) is triggered, the portrait special effect display information upon adding the special effect is displayed on the local-terminal display window 1004 (see the bottom page).

In the embodiments of the present disclosure, in the case that the local-terminal display window displays the portrait information of the target object, the portrait information in the local-terminal display window 1004 can be subjected to special effect addition if a user triggers the special effect control/identifier, and thus displaying portrait special effect on the local-terminal display window 1004 can be achieved, thereby enhancing the interest of video communication.

In some embodiments, the special effect panel includes a plurality of special effect mode labels; and the special effect modes in some embodiments of the present disclosure include a portrait special effect, a filter special effect, and the like, wherein the portrait special effect is configured for portrait information in the display window, and the filter is configured for all environmental information in the display window, including portrait information and object information. One or more special effect identifiers are set in each special effect mode, so the special effect data corresponding to the special effect mode label refers to special effect data corresponding to the special effect identifier under the special effect mode label.

Correspondingly, the method for video communication in some embodiments of the present disclosure further includes:

in response to a trigger operation based on a special effect mode label, loading, in the case that the special effect data corresponding to the special effect mode label is not loaded into the memory, locally stored special effect data corresponding to the special effect mode label into the memory.

As can be seen from the above processes, in response to the trigger operation based on a special effect mode label, the terminal loads the locally stored special effect data corresponding to the triggered special effect mode label into the memory in the case that the special effect data corresponding to the triggered special effect mode label is not loaded into the memory.

In some embodiments, the plurality of special effect mode labels include a portrait special effect label, a filter special effect label, and the like, wherein the portrait special effect label includes a beauty label, a makeup label, a body shaping label, a filter label, and the like, and each special effect mode label corresponds to special effect data. In some embodiments, by default, in the case that the special effect panel is displayed, a first special effect mode label (e.g., a beauty label) in the special effect panel is automatically triggered first, and meanwhile, the special effect data corresponding to the beauty label is preloaded; and for a non-first special effect mode label, preloading of corresponding special effect data is achieved based on a trigger operation on the corresponding special effect mode label.

In some embodiments, the special effect panel includes a plurality of special effect mode labels, and said in response to the touch operation based on the special effect control, displaying the special effect panel on the video communication page and loading the locally stored special effect data into the memory includes: in response to the touch operation based on the special effect control, displaying the special effect panel on the video communication page, and loading locally stored first special effect data into the memory, the first special effect data being special effect data corresponding to a first special effect mode label triggered by default in the special effect panel.

The first special effect mode label triggered by default is the first special effect mode label described above or a special effect mode label triggered by default as set by a user, or a special effect mode label used last time, or a special effect mode label that is most used, or the like.

In the case of displaying the special effect panel, only the special effect data corresponding to the first special effect mode label triggered by default is loaded. As for other special effect mode labels, the special effect data is loaded only when these special effect mode labels are triggered. Therefore, the method further includes: in response to a second special effect mode label being triggered, loading, in the case that special effect data corresponding to the second special effect mode label is not loaded into the memory, locally stored second special effect data into the memory, the second special effect data being special effect data corresponding to the second special effect mode label.

The second special effect mode label is any special effect mode label of which the special effect data is not yet loaded into the memory.

The portrait special effects in the embodiments of the present disclosure include beauty, makeup, body shaping, and the like; in the case that the portrait special effect is beauty or makeup, human face information in the local-terminal display window is acquired, and the corresponding beauty special effect or makeup special effect is generated based on the human face information and the corresponding special effect application model data; and in the case that the portrait special effect is body shaping, human face information, body information, and the like in the local-terminal display window are acquired, and the corresponding body shaping special effect is generated based on the human face information, the body information and the corresponding special effect application model data.

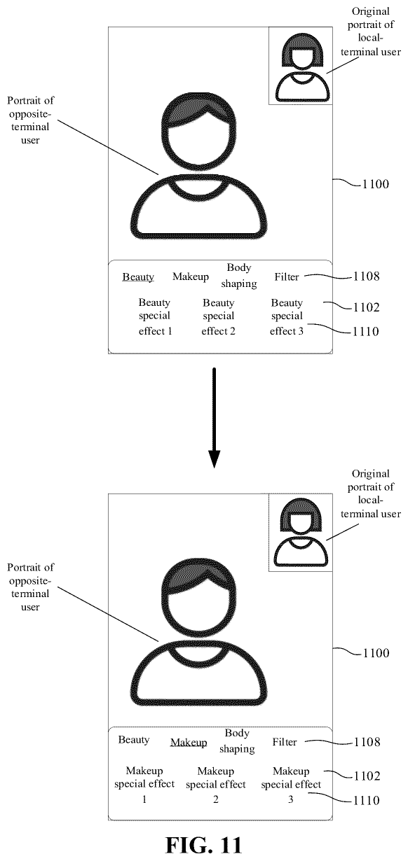

Referring to FIG. 11, a schematic diagram of video communication pages 1100 illustrating the display of a plurality of special effect mode labels on a special effect panel 1102 is shown. In the illustrated embodiment, the special effect panel 1102 displays special effect mode labels as a text such as a beauty label as “Beauty”, a makeup label as “Makeup”, a body shaping label as “Body shaping”, a filter label as “Filter” in sequence. By triggering the corresponding special effect mode label, the special effect mode can be switched, and the preloading of the corresponding special effect data is performed. In some embodiments, in the case that the beauty label is switched to the makeup label and the special effect data corresponding to the makeup label is not loaded into the memory, the special effect data corresponding to the makeup label is loaded into the memory. The video communication page 1100 displayed at the top of FIG. 11 shows that the special effect mode is beauty with the text “Beauty” underlined. The video communication page 1100 displayed at the bottom of FIG. 11 shows that the special effect mode is makeup with the text “Makeup” underlined.

In the embodiments of the present disclosure, the preloading of the special effect data is achieved based on the trigger operation on the special effect mode label, and the preloading of the corresponding special effect data is performed in the case that the special effect mode label is triggered. Because the triggering of the special effect mode indicates that the special effect under the special effect mode label is likely to be used subsequently, loading of the special effect data at the moment can improve the special effect generation efficiency during the subsequent use of the special effect mode. In some embodiments, in the case that the special effect mode label is triggered, the corresponding special effect data is preloaded, that is, the corresponding special effect data is preloaded when needed, and is not preloaded in the case that there is no intention to use, thereby avoiding the waste of preloaded resources.

In some embodiments, the special effect panel 1102 includes a special effect label display region 1108 and a special effect identifier display region 1110. The special effect label display region is configured to display a plurality of special effect mode labels such as beauty, markup, body shaping, and filter. The special effect identifier display region is configured to display a special effect identifier under each special effect mode label. As illustrated in the special effect panel 1102 on the video communication page 1100 shown at the top of FIG. 11, the special effect mode is beauty. The beauty mode “Beauty” is displayed on the special effect label display region 1108, and the corresponding special effect identifiers (i.e., beauty special effect 1, beauty special effect 2, and beauty special effect 3) are shown in the special effect identifier display region 1110. As illustrated in the special effect panel 1102 on the video communication page 1100 shown at the bottom of FIG. 11, the special effect mode is makeup. The makeup mode “Makeup” is displayed on the special effect label display region 1108, and the corresponding special effect identifiers (i.e., makeup special effect 1, makeup special effect 2, and makeup special effect 3) are shown in the special effect identifier display region 1110.

Correspondingly, the method for video communication in the embodiments of the present disclosure further includes:
displaying, in response to a trigger operation based on a special effect mode label, a special effect identifier corresponding to the special effect mode label in the special effect identifier display region.

In the embodiments of the present disclosure, the special effect panel includes a special effect identifier display region configured to display the special effect identifier under each special effect mode label, that is, a plurality of special effect mode labels use the same special effect identifier display region to display the special effect identifiers. In the case that any special effect mode label is triggered, a plurality of special effect identifiers under the special effect mode label are displayed in the special effect identifier display region.

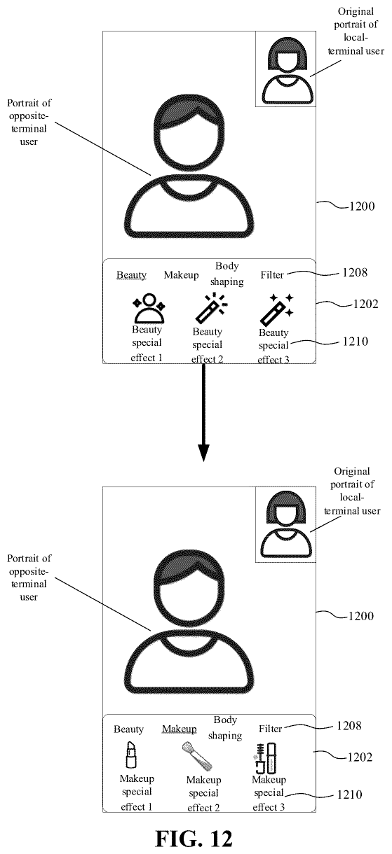

Referring to FIG. 12, which shows that in the case that the beauty label is triggered, the special effect identifiers, such as a beauty special effect 1, a beauty special effect 2, and a beauty special effect 3, under the beauty label are displayed in the special effect identifier display region 1210; and in the case that the makeup label is triggered, the special effect identifiers, such as a makeup special effect 1, a makeup special effect 2, and a makeup special effect 3, under the makeup label are displayed in the special effect identifier display region. As illustrated in the special effect panel 1202 on the video communication page 1200 shown at the top of FIG. 12, the special effect mode is beauty. The beauty mode “Beauty” is displayed on the special effect label display region 1208, and the corresponding special effect identifiers (i.e., icon corresponding beauty special effect 1, icon corresponding beauty special effect 2, and icon corresponding beauty special effect 3) are shown in the special effect identifier display region 1210. As illustrated in the special effect panel 1202 on the video communication page 1200 shown at the bottom of FIG. 12, the special effect mode is makeup. The makeup mode “Makeup” is displayed on the special effect label display region 1208, and the corresponding special effect identifiers (i.e., icon (lipstick) corresponding makeup special effect 1, icon (brush) corresponding makeup special effect 2, and icon (mascara) corresponding makeup special effect 3) are shown in the special effect identifier display region 1210.

The special effect identifiers under a plurality of special effect mode labels are displayed in the same special effect identifier display region, and are switched to display by triggering the special effect mode labels, which saves page display resources.

In some embodiments, said displaying, in response to the touch operation based on the special effect control, the special effect panel on the video communication page includes:
displaying, in response to the touch operation based on the special effect control, a half-screen page on the video communication page; and
displaying the special effect panel on the half-screen page.

The half-screen page on the video communication page is an upper-layer page of the video communication page, and the page size of the half-screen page is smaller than the page size of the video communication page.

Referring to FIGS. 5, FIGS. 7-8, and 10-12, a schematic diagram of a special effect panel is shown, where the special effect panel is displayed at the bottom of the video communication page and is displayed in the form of a half-screen page. By displaying the special effect panel on the half-screen page, the special effect panel is displayed on the premise of avoiding affecting the video communication; and it is also convenient for users to continue to return to the video communication page for interaction upon viewing the display information in the special effect panel, so that the operation efficiency and the user experience are improved.

In some embodiments of the present disclosure, a local terminal (i.e., a first terminal whose user initiates the communication) is used as an example to illustrate the method. It should be noted that, upon the start of the communication, the method may also be performed by an opposite terminal (a second terminal whose user accepts the invitation for the communication). That is, the video communication pages illustrated in FIGS. 4, 5, 7-8, and 10-12 can be the video communication pages displayed on the second terminal in which a second user of the second terminal becomes a local-terminal user, and a first user of the first terminal becomes an opposite-terminal user.

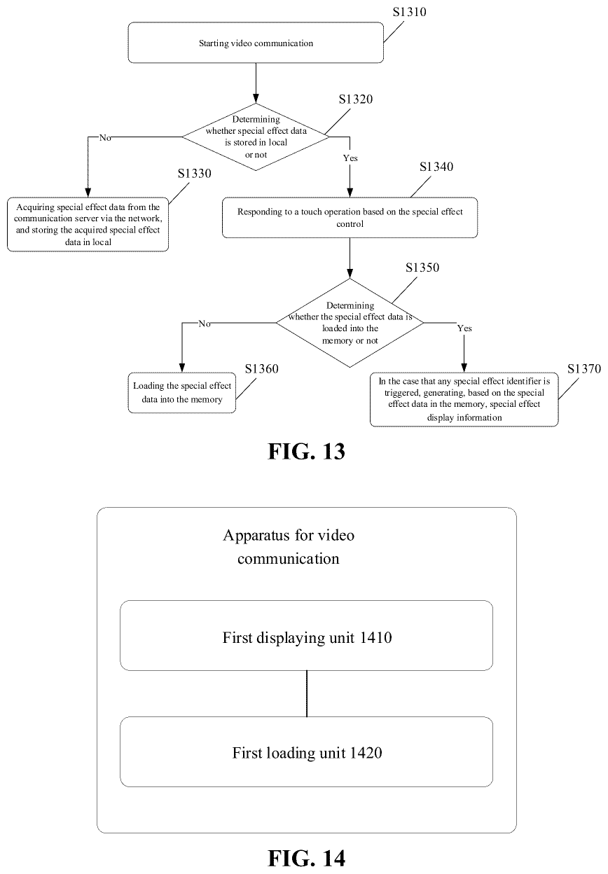

Referring to FIG. 13, a special effect data loading process under a video communication scenario is shown, where the process includes the following processes.

In S1310, video communication is started.

In some embodiments, video communication is started in response to a video communication instruction.

In S13200, it is determined whether special effect data is stored in the local terminal or not, if not, process S1330 is executed, and if yes, process S1340 is executed.

In S1330, the special effect data is acquired from the communication server via the network, and the acquired special effect data is stored in the local terminal.

In S1340, a touch operation based on the special effect control is responded to.

In S1350, it is determined whether the special effect data is loaded into the memory or not, if not, process S1360 is executed, and if yes, process S1170 is executed.

In S1360, the special effect data is loaded into the memory.

In S1370, in the case that any special effect identifier is triggered, special effect display information is generated based on the special effect data in the memory.

In some embodiments, in one application starting life cycle, special effect data is acquired from the communication server; and in the case that the special effect data is acquired and stored before the current life cycle, the special effect data does not need to be acquired repeatedly within the current life cycle, namely, in the case that the special effect data exists in the local terminal, the special effect data loaded through the network is updated in the local terminal and then used in the next video communication.

In the process of acquiring the special effect data from the communication server in process S1130, in the case that the acquisition of the special effect data from the communication server fails, the normal use of a special effect function is achieved based on the locally stored basic special effect data, wherein the basic special effect data is special effect data which ensures normal use of a special effect function and contains basic special effect template data.

It should be noted that any of the above methods in the embodiments of the present disclosure can be combined based on specific implementation situations, and have corresponding beneficial effects, which are not repeated herein.

FIG. 14 is a block diagram of an apparatus for video communication according to some embodiments. Referring to FIG. 14, the apparatus includes:
a first displaying unit 1410, configured to display a video communication page, the video communication page displaying a special effect control; and
a first loading unit 1420, configured to in response to a touch operation based on the special effect control, display a special effect panel on the video communication page and load locally stored special effect data into a memory;
wherein the special effect panel displays a special effect identifier, and the special effect data is used to generate, in the case that the special effect identifier is triggered, special effect display information to be displayed on the video communication page.

In some embodiments, the first displaying unit 1410 includes:
a special effect data acquiring subunit, configured to display the video communication page, and in the case that the special effect data is not stored in the apparatus, acquire the special effect data and store the special effect data in the apparatus.

In some embodiments, the apparatus further includes:
a special effect display information generating unit, configured to in response to the special effect identifier being triggered, generate, based on the special effect data corresponding to the special effect identifier in the memory, the special effect display information; and
a second displaying unit, configured to display the special effect display information on the video communication page.

In some embodiments, the video communication page includes a local-terminal display window configured to display environmental information around a local terminal; and
the second displaying unit is configured to display the special effect display information on the local-terminal display window.

In some embodiments, the video communication page includes a local-terminal display window configured to display environmental information around a local terminal; the special effect display information includes portrait special effect display information;
the special effect display information generating unit includes:
a portrait special effect generating subunit, configured to in the case that the environmental information around the local terminal includes portrait information of a target object, generate, based on the portrait information and the special effect data corresponding to any special effect identifier, portrait special effect display information corresponding to the target object; and
the second displaying unit includes:
a replacing and displaying subunit, configured to replace the portrait information of the target object in the local-terminal display window with the portrait special effect display information.

In some embodiments, the special effect panel includes a plurality of special effect mode labels; and
the first loading unit 1420 is configured to in response to the touch operation based on the special effect control, display the special effect panel on the video communication page and load locally stored first special effect data into the memory, the first special effect data being special effect data corresponding to a first special effect mode label triggered by default in the special effect panel.

In some embodiments, the apparatus further includes:
a second loading unit, configured to in response to a second special effect mode label being triggered, load, in the case that special effect data corresponding to the second special effect mode label is not loaded into the memory, locally stored second special effect data into the memory, the second special effect data being special effect data corresponding to the second special effect mode label.

In some embodiments, the special effect panel includes a special effect label display region and a special effect identifier display region, the special effect label display region being configured to display a plurality of special effect mode labels; and
the apparatus further includes:
a fourth displaying unit, configured to display, in response to a trigger operation based on a special effect mode label, a special effect identifier corresponding to the special effect mode label in the special effect identifier display region.

In some embodiments, the first displaying unit 1410 includes:
a fifth displaying subunit, configured to display, in response to the touch operation based on the special effect control, a half-screen page on the video communication page; and
a sixth displaying subunit, configured to display the special effect panel on the half-screen page.

With regard to the apparatus in the above embodiments, the specific manner in which each module performs the operations has been described in detail in the embodiments related to the method, and is not repeated in detail herein.

In some embodiments, a non-transitory computer-readable storage medium including instructions is further provided. In some embodiments, the computer-readable storage medium is a ROM, a random-access memory (RAM), a CD-ROM, a magnetic tape, a floppy disk, an optical data storage device, or the like; the instructions in the computer-readable storage medium, when loaded and executed by a processor of an electronic device, cause the electronic device to perform:
displaying a video communication page, the video communication page displaying a special effect control; and
in response to a touch operation based on the special effect control, displaying a special effect panel on the video communication page and loading locally stored special effect data into a memory;
wherein the special effect panel displays a special effect identifier, and the special effect data is used to generate, in the case that the special effect identifier is triggered, special effect display information to be displayed on the video communication page.

In some embodiments, the instructions in the computer-readable storage medium, when loaded and executed by a processor of an electronic device, cause the electronic device to perform:
displaying the video communication page, and in the case that the special effect data is not stored in the electronic device, acquiring the special effect data and storing the special effect data in the electronic device.

In some embodiments, the instructions in the computer-readable storage medium, when loaded and executed by a processor of an electronic device, cause the electronic device to perform:
in response to the special effect identifier being triggered, generating, based on the special effect data corresponding to the special effect identifier in the memory, the special effect display information; and
displaying the special effect display information on the video communication page.

In some embodiments, the video communication page displays a local-terminal display window configured to display environmental information around a local terminal; and
the instructions in the computer-readable storage medium, when loaded and executed by a processor of an electronic device, cause the electronic device to perform:
displaying the special effect display information on the local-terminal display window.

In some embodiments, the video communication page displays a local-terminal display window configured to display environmental information around a local terminal; and the special effect display information includes portrait special effect display information; and
the instructions in the computer-readable storage medium, when loaded and executed by a processor of an electronic device, cause the electronic device to perform:
in the case that the environmental information around the local terminal includes portrait information of a target object, generating, based on the portrait information and the special effect data corresponding to the special effect identifier, portrait special effect display information corresponding to the target object; and
replacing the portrait information of the target object in the local-terminal display window with the portrait special effect display information.

In some embodiments, the special effect panel includes a plurality of special effect mode labels; and the instructions in the computer-readable storage medium, when loaded and executed by a processor of an electronic device, cause the electronic device to perform:
in response to the touch operation based on the special effect control, displaying the special effect panel on the video communication page and loading locally stored first special effect data into the memory, the first special effect data being special effect data corresponding to a first special effect mode label triggered by default in the special effect panel.

In some embodiments, the instructions in the computer-readable storage medium, when loaded and executed by a processor of an electronic device, cause the electronic device to perform:
in response to a second special effect mode label being triggered, loading, in the case that special effect data corresponding to the second special effect mode label is not loaded into the memory, locally stored second special effect data into the memory, the second special effect data being special effect data corresponding to the second special effect mode label.

In some embodiments, the special effect panel includes a special effect label display region and a special effect identifier display region, the special effect label display region being configured to display a plurality of special effect mode labels; and
the instructions in the computer-readable storage medium, when loaded and executed by a processor of an electronic device, cause the electronic device to perform:
displaying, in response to a trigger operation based on a special effect mode label, a special effect identifier corresponding to the special effect mode label in the special effect identifier display region.

In some embodiments, the instructions in the computer-readable storage medium, when loaded and executed by a processor of an electronic device, cause the electronic device to perform:
displaying, in response to the touch operation based on the special effect control, a half-screen page on the video communication page; and
displaying the special effect panel on the half-screen page.

In some embodiments, a computer program product including computer programs is further provided. The computer programs are stored in a readable storage medium, and the computer programs, when loaded from the readable storage medium and run by at least one processor of a computer device, cause the computer device to perform:
displaying a video communication page, the video communication page displaying a special effect control; and
in response to a touch operation based on the special effect control, displaying a special effect panel on the video communication page and loading locally stored special effect data into a memory;
wherein the special effect panel displays a special effect identifier, and the special effect data is used to generate, in the case that the special effect identifier is triggered, special effect display information to be displayed on the video communication page.

In some embodiments, the computer programs, when loaded from the readable storage medium and run by at least one processor of a computer device, cause the computer device to perform:
displaying the video communication page, and in the case that the special effect data is not stored in the electronic device, acquiring the special effect data and storing the special effect data in the electronic device.

In some embodiments, the computer programs, when loaded from the readable storage medium and run by at least one processor of a computer device, cause the computer device to perform:
in response to the special effect identifier being triggered, generating, based on the special effect data corresponding to the special effect identifier in the memory, the special effect display information; and
displaying the special effect display information on the video communication page.

In some embodiments, the video communication page displays a local-terminal display window configured to display environmental information around a local terminal; and
the computer programs, when loaded from the readable storage medium and run by at least one processor of a computer device, cause the computer device to perform:
displaying the special effect display information on the local-terminal display window.

In some embodiments, the video communication page displays a local-terminal display window configured to display environmental information around a local terminal; the special effect display information includes portrait special effect display information; and
the computer programs, when loaded from the readable storage medium and run by at least one processor of a computer device, cause the computer device to perform:
in the case that the environmental information around the local terminal includes portrait information of a target object, generating, based on the portrait information and the special effect data corresponding to the special effect identifier, portrait special effect display information corresponding to the target object; and
replacing the portrait information of the target object in the local-terminal display window with the portrait special effect display information.

In some embodiments, the special effect panel includes a plurality of special effect mode labels; and the computer programs, when loaded from the readable storage medium and run by at least one processor of a computer device, cause the computer device to perform:
in response to the touch operation based on the special effect control, displaying the special effect panel on the video communication page and loading locally stored first special effect data into the memory, the first special effect data being special effect data corresponding to a first special effect mode label triggered by default in the special effect panel.

In some embodiments, the computer programs, when loaded from the readable storage medium and run by at least one processor of a computer device, cause the computer device to perform:
in response to a second special effect mode label being triggered, loading, in the case that special effect data corresponding to the second special effect mode label is not loaded into the memory, locally stored second special effect data into the memory, the second special effect data being special effect data corresponding to the second special effect mode label.

In some embodiments, the special effect panel includes a special effect label display region and a special effect identifier display region, the special effect label display region being configured to display a plurality of special effect mode labels; and
the computer programs, when loaded from the readable storage medium and run by at least one processor of a computer device, cause the computer device to perform:
displaying, in response to a trigger operation based on a special effect mode label, a special effect identifier corresponding to the special effect mode label in the special effect identifier display region.

In some embodiments, the computer programs, when loaded from the readable storage medium and run by at least one processor of a computer device, cause the computer device to perform:
displaying, in response to the touch operation based on the special effect control, a half-screen page on the video communication page; and
displaying the special effect panel on the half-screen page.

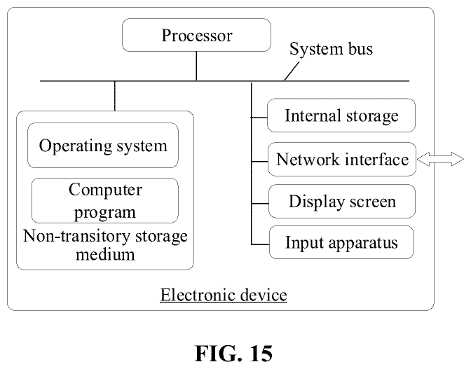

FIG. 15 is a block diagram of an electronic device for video communication according to some embodiments, wherein the electronic device is a terminal in some embodiments, and an internal structure thereof is shown in FIG. 15. The electronic device includes a processor, a memory, a network interface, a display screen, and an input apparatus which are connected via a system bus. The processor of the electronic device is configured to provide computing and control capabilities. The memory of the electronic device includes a non-transitory storage medium and an internal storage. The non-transitory storage medium stores an operating system and a computer program. The internal storage provides an operation environment for the operating system and the computer programs in the non-transitory storage medium. The network interface of the electronic device is used to be connected to and communicate with an external terminal via a network. The computer programs, when loaded and run by a processor, cause the processor to perform a method for video communication. The display screen of the electronic device is a liquid crystal display screen or an electronic ink display screen, and the input apparatus of the electronic device is a touch layer covering the display screen, or a key, a trackball, or a touchpad arranged on the housing of the electronic device, or an external keyboard, a touchpad, or a mouse, or the like.

It should be noted by those skilled in the art that the structure shown in FIG. 15 is a block diagram of only a portion, associated with the solutions of the present disclosure, of the structure and does not constitute a limitation on the electronic device to which the solutions of the present disclosure is applied, and that a particular electronic device may include more or fewer components than those shown in the figure, or combine some components, or have different component arrangements.

In some embodiments, an electronic device for video communication is further provided. The electronic device includes:
a processor; and
a memory, configured to store instructions executable by the processor;
wherein the processor, when loading and executing the instructions, is caused to perform:
displaying a video communication page, the video communication page displaying a special effect control; and
in response to a touch operation based on the special effect control, displaying a special effect panel on the video communication page and loading locally stored special effect data into a memory;
wherein the special effect panel displays a special effect identifier, and the special effect data is used to generate, in the case that the special effect identifier is triggered, special effect display information to be displayed on the video communication page.

In some embodiments, the processor, when loading and executing the instructions, is caused to perform:
displaying the video communication page, and in the case that the special effect data is not stored in the electronic device, acquiring the special effect data and storing the special effect data in the electronic device.

In some embodiments, the processor, when loading and executing the instructions, is caused to perform:
in response to the special effect identifier being triggered, generating, based on the special effect data corresponding to the special effect identifier in the memory, the special effect display information; and
displaying the special effect display information on the video communication page.

In some embodiments, the video communication page displays a local-terminal display window configured to display environmental information around a local terminal; and
the processor, when loading and executing the instructions, is caused to perform:
displaying the special effect display information on the local-terminal display window.

In some embodiments, the video communication page displays a local-terminal display window configured to display environmental information around a local terminal; the special effect display information includes portrait special effect display information; and
the processor, when loading and executing the instructions, is caused to perform:
in the case that the environmental information around the local terminal includes portrait information of a target object, generating, based on the portrait information and the special effect data corresponding to the special effect identifier, portrait special effect display information corresponding to the target object; and
replacing the portrait information of the target object in the local-terminal display window with the portrait special effect display information.

In some embodiments, the special effect panel includes a plurality of special effect mode labels; and the processor, when loading and executing the instructions, is caused to perform:
in response to the touch operation based on the special effect control, displaying the special effect panel on the video communication page and loading locally stored first special effect data into the memory, the first special effect data being special effect data corresponding to a first special effect mode label triggered by default in the special effect panel.

In some embodiments, the processor, when loading and executing the instructions, is caused to perform:
in response to a second special effect mode label being triggered, loading, in the case that special effect data corresponding to the second special effect mode label is not loaded into the memory, locally stored second special effect data into the memory, the second special effect data being special effect data corresponding to the second special effect mode label.

In some embodiments, the special effect panel includes a special effect label display region and a special effect identifier display region, the special effect label display region being configured to display a plurality of special effect mode labels; and the processor, when loading and executing the instructions, is caused to perform:
displaying, in response to a trigger operation based on a special effect mode label, a special effect identifier corresponding to the special effect mode label in the special effect identifier display region.

In some embodiments, the processor, when loading and executing the instructions, is caused to perform:
displaying, in response to the touch operation based on the special effect control, a half-screen page on the video communication page; and
displaying the special effect panel on the half-screen page.

What is claimed is:

1. A method for video communication, performed in an electronic device, comprising:
displaying a video communication page, the video communication page displaying a special effect control; and
in response to a touch operation based on the special effect control, displaying a special effect panel on the video communication page and loading locally stored special effect data into a memory, wherein the locally stored special effect data is data stored in external storage which is different from the memory;
wherein the special effect panel displays a special effect identifier, and the special effect data is used to generate, in a case that the special effect identifier is triggered, special effect display information to be displayed on the video communication page.

2. The method according to claim 1, wherein said displaying the video communication page comprises:
displaying the video communication page, and in a case that the special effect data is not stored in the electronic device, acquiring the special effect data from a communication server and storing the special effect data in the electronic device.

3. The method according to claim 1, wherein the method further comprises:
in response to the special effect identifier being triggered, generating, based on the special effect data corresponding to the special effect identifier in the memory, the special effect display information; and
displaying the special effect display information on the video communication page.

4. The method according to claim 3, wherein the video communication page displays a local-terminal display window configured to display environmental information around a local terminal; and
said displaying the special effect display information on the video communication page comprises:
displaying the special effect display information on the local-terminal display window.

5. The method according to claim 3, wherein the video communication page displays a local-terminal display window configured to display environmental information around a local terminal; and the special effect display information comprises portrait special effect display information;
said in response to the special effect identifier being triggered, generating, based on the special effect data corresponding to the special effect identifier in the memory, the special effect display information comprises:
in a case that the environmental information around the local terminal comprises portrait information of a target object, generating, based on the portrait information and the special effect data corresponding to the special effect identifier, portrait special effect display information corresponding to the target object; and
said displaying the special effect display information on the video communication page comprises:
replacing the portrait information of the target object in the local-terminal display window with the portrait special effect display information.

6. The method according to claim 1, wherein the special effect panel comprises a plurality of special effect mode labels; and
said in response to the touch operation based on the special effect control, displaying the special effect panel on the video communication page and loading the locally stored special effect data into the memory comprises:
in response to the touch operation based on the special effect control, displaying the special effect panel on the video communication page and loading locally stored first special effect data into the memory, the first special effect data being special effect data corresponding to a first special effect mode label triggered by default in the special effect panel.

7. The method according to claim 6, wherein the method further comprises:
in response to a second special effect mode label being triggered, loading, in a case that special effect data corresponding to the second special effect mode label is not loaded into the memory, locally stored second special effect data into the memory, the second special effect data being special effect data corresponding to the second special effect mode label.

8. The method according to claim 1, wherein the special effect panel comprises a special effect label display region and a special effect identifier display region, the special effect label display region being configured to display a plurality of special effect mode labels; and
the method further comprises:
displaying, in response to a trigger operation based on a special effect mode label, a special effect identifier corresponding to the special effect mode label in the special effect identifier display region.

9. The method according to claim 1, wherein said displaying, in response to the touch operation based on the special effect control, the special effect panel on the video communication page comprises:
displaying, in response to the touch operation based on the special effect control, a half-screen page on the video communication page; and
displaying the special effect panel on the half-screen page.

10. An electronic device for video communication, comprising:
a processor; and
a memory, configured to store instructions executable by the processor;
wherein the processor, when loading and executing the instructions, is caused to perform:
displaying a video communication page, the video communication page displaying a special effect control; and
in response to a touch operation based on the special effect control, displaying a special effect panel on the video communication page and loading locally stored special effect data into a memory, wherein the locally stored special effect data is data stored in external storage which is different from the memory;
wherein the special effect panel displays a special effect identifier, and the special effect data is used to generate, in a case that the special effect identifier is triggered, special effect display information to be displayed on the video communication page.

11. The electronic device according to claim 10, wherein the processor, when loading and executing the instructions, is caused to perform:
displaying the video communication page, and in a case that the special effect data is not stored in the electronic device, acquiring the special effect data from a communication server, and storing the special effect data in the electronic device.

12. The electronic device according to claim 10, wherein the processor, when loading and executing the instructions, is caused to perform:
in response to the special effect identifier being triggered, generating, based on the special effect data corresponding to the special effect identifier in the memory, the special effect display information; and
displaying the special effect display information on the video communication page.

13. The electronic device according to claim 12, wherein the video communication page displays a local-terminal display window configured to display environmental information around a local terminal; and
the processor, when loading and executing the instructions, is caused to perform:
displaying the special effect display information on the local-terminal display window.

14. The electronic device according to claim 12, wherein the video communication page displays a local-terminal display window configured to display environmental information around a local terminal; and the special effect display information comprises portrait special effect display information; and
the processor, when loading and executing the instructions, is caused to perform:
in a case that the environmental information around the local terminal comprises portrait information of a target object, generating, based on the portrait information and the special effect data corresponding to the special effect identifier, portrait special effect display information corresponding to the target object; and
replacing the portrait information of the target object in the local-terminal display window with the portrait special effect display information.

15. The electronic device according to claim 10, wherein the special effect panel comprises a plurality of special effect mode labels; and
the processor, when loading and executing the instructions, is caused to perform:
in response to the touch operation based on the special effect control, displaying the special effect panel on the video communication page and loading locally stored first special effect data into the memory, the first special effect data being special effect data corresponding to a first special effect mode label triggered by default in the special effect panel.

16. The electronic device according to claim 15, wherein the processor, when loading and executing the instructions, is caused to perform:
in response to a second special effect mode label being triggered, loading, in a case that special effect data corresponding to the second special effect mode label is not loaded into the memory, locally stored second special effect data into the memory, the second special effect data being special effect data corresponding to the second special effect mode label.

17. The electronic device according to claim 10, wherein the special effect panel comprises a special effect label display region and a special effect identifier display region, the special effect label display region being configured to display a plurality of special effect mode labels; and
the processor, when loading and executing the instructions, is caused to perform:
displaying, in response to a trigger operation based on a special effect mode label, a special effect identifier corresponding to the special effect mode label in the special effect identifier display region.

18. The electronic device according to claim 10, wherein the processor, when loading and executing the instructions, is caused to perform:
displaying, in response to the touch operation based on the special effect control, a half-screen page on the video communication page; and
displaying the special effect panel on the half-screen page.

19. A non-transitory computer-readable storage medium storing instructions executable by a processor of an electronic device, wherein the instructions, when loaded and executed by the processor of the electronic device, cause the electronic device to perform:
displaying a video communication page, the video communication page displaying a special effect control; and
in response to a touch operation based on the special effect control, displaying a special effect panel on the video communication page and loading locally stored special effect data into a memory;
wherein the special effect panel displays a special effect identifier, and the special effect data is used to generate, in a case that the special effect identifier is triggered, special effect display information to be displayed on the video communication page.

20. The non-transitory computer-readable storage medium according to claim 19, wherein the instructions in the computer-readable storage medium, when loaded and executed by the processor of the electronic device, cause the electronic device to perform:
displaying the video communication page, and in a case that the special effect data is not stored in the electronic device, acquiring the special effect data from a communication server and storing the special effect data in the electronic device.
